(19) United States
(12) Patent Application Publication
(10) Pub. No.: US 2007/0298268 A1
(43) Pub. Date: Dec. 27, 2007

(54) Encapsulated optoelectronic device

(75) Inventor: Deborah Ann Haitko, Schenectady, NY (US)

Correspondence Address: FAY SHARPE LLP, 1100 SUPERIOR AVENUE, SEVENTH FLOOR, CLEVELAND, OH, 44114, US

(73) Assignee: GELcore LLC

(21) Appl. No.: 11/475,803

(22) Filed: Jun. 27, 2006

(51) Int. Cl. B32B 27/06; B32B 27/38

(52) U.S. Cl. 428/447; 428/448

(57) ABSTRACT

The present invention provides a method of integrating an encapsulant into an optoelectronic device, comprising: (a) contacting the optoelectronic device to be encapsulated with an adhesion promoter composition comprising an epoxy-functional silane and an amino-functional silane; and (b) applying an encapsulant formulation onto the optoelectronic device that has been treated with the adhesion promoter composition. Also provided is optoelectronic device such as LED device made using the method.

### BACKGROUND OF THE INVENTION

The present invention is generally related to an optoelectronic device, including an organic thermosetting material as an encapsulant. More particularly, the device includes an adhesion promoter composition comprised of an epoxy-functional silane and an amino-functional silane.

The fabrication of an optoelectronic device depends heavily upon the structural integrity of its various components. For instance, the bonding strength between encapsulant and optoelectronic device is important for the duration and performance of the device. However, delamination can occur between the organic-and inorganic surfaces due to temperature variations and other factors.

U.S. Pat. No. 6,534,581 discloses a multi-part curable silicone composition for silicone adhesive applications in the automotive, electronic, construction, appliance, and aerospace industries. The composition comprises, among many other components, an adhesion promoter selected from at least one amino-functional alkoxysilane, at least one epoxy-functional alkoxysilane, a reaction product of at least one amino-functional alkoxysilane and at least one epoxy-functional alkoxysilane, and at least one vinyl trialkoxysilane. However, the adhesion promoter is used in combination with the curable silicone composition, which can have a negative effect on the properties of the organic material. U.S. Pat. No. 6,762,113 discloses a method for coating a semiconductor substrate with a mixture containing an adhesion promoter. The method uses a coating mixture of an α-amino propyltriethoxysilane in organic solution and a photopolymer material with mercapto-ester in solution.

The present invention advantageously provides a novel method of constructing an optoelectronic device, in which an adhesion promoter composition comprising an epoxy-functional silane and an amino-functional silane is separately applied, such as by spraying, on the optoelectronic device, before the device is encapsulated. Optoelectronic devices made according to the invention have improved properties.

### BRIEF DESCRIPTION OF THE INVENTION

One aspect of the present invention is a method of constructing an optoelectronic device such as an LED device comprising: (a) contacting an optoelectronic component to be encapsulated with an adhesion promoter composition comprising an epoxy-functional silane and an amino-functional silane; and (b) applying an encapsulant onto the optoelectronic component that has been treated with the adhesion promoter composition.

Another aspect of the invention is an optoelectronic device, such as an LED device, including an optoelectronic component at least partially surrounded by an encapsulant and an adhesion promoter composition comprising an epoxy-functional silane and an amino-functional silane located between at least a portion of said encapsulant and said optoelectronic device.

### BRIEF DESCRIPTION OF THE DRAWINGS

FIG. 1 shows a schematic diagram of an LED device according to an embodiment of the present invention;

FIG. 2 shows a schematic diagram of an LED array on a substrate according to one embodiment of the present invention;

FIG. 3 shows a schematic diagram of an LED device according to another embodiment of the present invention; and

FIG. 4 shows a schematic diagram of a vertical cavity surface emitting laser device according to still another embodiment of the present invention.

### DETAILED DESCRIPTION OF THE INVENTION

The present invention provides a method of integrating an organic thermosetting material such as encapsulant into an optoelectronic device, comprising:

(a) contacting the optoelectronic component to be encapsulated with an adhesion promoter composition comprising an epoxy-functional silane and an amino-functional silane; and

(b) applying an encapsulant onto the optoelectronic component that has been treated with the adhesion promoter composition.

Any optoelectronic device that benefits from encapsulation may benefit from the present invention. Exemplary optoelectronic devices include, but are not limited to, light emitting diodes (LEDs), charge coupled devices (CCDs), large scale integrations (LSIs), photodiodes, vertical cavity surface emitting lasers (VCSELs), phototransistors, photocouplers, and optoelectronic couplers etc.

An optoelectronic device to be encapsulated typically comprises many parts that are made from a wide variety of organic or inorganic materials. For example, optoelectronic components may include semiconductor chip, lead frame, bond wire, solder, electrode, pad, contact layer, phosphor layer, and dielectric layer etc. These optoelectronic components may be made of or made from materials, for example, metals such as aluminum, gold, silver, tin-lead, nickel, copper, and iron, and their alloys; silicon; passivation coatings such as silicon dioxide and silicon nitride; aluminum nitride; alumina; fluorocarbon polymers such as polytetrafluoroethylene and polyvinylfluoride; polyamides such as Nylon; organic resins such as polyimide; polyesters; ceramics; plastic; and glass etc. Taking a LED chip as an illustrative example, it may contain any desired Group III-V compound semiconductor layers, such as GaAs, GaAlAs, GaN, InGaN, GaP etc., or Group II-VI compound semiconductor layers such as ZnSe, ZnSSe, CdTe, etc., or Group IV-IV semiconductor layers, such as SiC. The phosphor layer or coating, as another illustrative example, may be cerium-doped yittrium aluminum oxide Y₃Al₅O₁₂ garnet (“YAG:Ce”). Other suitable phosphors are based on YAG doped with more than one type of rare earth ions, such as (Y_{1-x-y}GdₓCe_{y})₃Al₅O₁₂ (“YAG:Gd,Ce”), (Y₁₋ₓCeₓ)₃(Al_{5-y}Ga_{y})O₁₂ (“YAG:Ga,Ce”), (Y_{1-x-y}GdₓCe_{y})(Al_{5-z}Ga_{z})O₁₂ (“YAG:Gd,Ga,Ce”), and (Gd₁₋ₓCeₓ)Sc₂Al₃O₁₂ (“GSAG”), where 0≦x≦1, 0≦y≦1, 0≦z≦5, and x+y≦1. Related phosphors include Lu₃Al₅O₁₂ and Tb₂Al₅O₁₂, both doped with cerium. In addition, these cerium-doped garnet phosphors may also be additionally doped with small amounts of Pr (such as about 0.1-2 mole percent) to produce an additional enhancement of red emission. Non-limiting examples of phosphors that are efficiently excited by radiation of 300 nm to about 500 nm include green-emitting phosphors such as Ca₈Mg(SiO₄)₄Cl₂:Eu²⁺, Mn²⁺; GdBO₃:Ce³⁺, Tb³⁺; CeMgAl₁₁O₁₉:Tb³⁺; Y₂SiO₅:Ce³⁺, Tb³⁺; and BaMg₂Al₁₆O₂₇:Eu²⁺, Mn²⁺ etc.; red-emitting phosphors such as Y₂O₃:Bi³⁺,Eu³⁺; Sr₂P₂O₇:Eu²⁺; Mn²⁺; SrMgP₂O₇:Eu²⁺,Mn²⁺; (Y,Gd)(V,B)O₄:Eu³⁺; and 3.5MgO.0.5MgF₂.GeO₂:Mn⁴⁺ (magnesium fluorogermanate) etc.; blue-emitting phosphors such as BaMg₂Al₁₆O₂₇:Eu²⁺; Sr₅(PO₄)₁₀Cl₂:Eu²⁺; (Ba,Ca,Sr)(PO₄)₁₀(Cl,F)₂:Eu²⁺; and (Ca,Ba,Sr)(Al,Ga)₂S₄:Eu²⁺ etc.; and yellow-emitting phosphors such as (Ba,Ca,Sr)(PO₄)₁₀(Cl,F)₂:Eu²⁺,Mn²⁺ etc.

The adhesion promoter composition may be applied to the optoelectronic device to be encapsulated by any conventional means that are known to a person skilled in the art, for example, spraying, syringe dispensing, screen or stencil printing, ink jet printing, or simple pipetting.

In an exemplary embodiment, the adhesion promoter composition of the present invention is used to improve the bonding between inorganic or metal material and organic thermosetting encapsulant material, or organic resin transfer molding material.

The adhesion promoter composition of the present invention generally comprises an epoxy-functional silane and an amino-functional silane. The adhesion promoter composition may also contain any product of reaction between epoxy-functional silane and amino-functional silane, for example, amino hydrogen may attack the epoxy group and open the epoxy ring.

According to an exemplary embodiment of the present invention, the epoxy-functional silane in the adhesion promoter composition has a Formula (I):

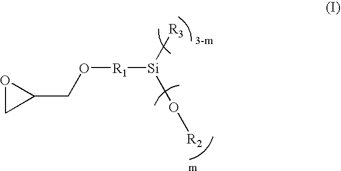

in which R₁ is a C₁₋₆ hydrocarbon divalent group, R₂ is a C₁₋₆ hydrocarbon group, R₂ is a C₁₋₆ saturated or unsaturated hydrocarbon group, and m=1, 2, or 3. A particularly preferred epoxy-functional silane is 3-glycidoxypropyltrimethoxysilane, which corresponds to Formula (I) wherein R₁ is 1,3-propylene, R₂ is methyl, and m=3.

Specific examples of epoxy-functional silane include, but are not limited to, 3-glycidoxy-1,2-epoxy-4-(2-trimethoxysilylethyl)cyclohexane; 1,2-epoxy-2-methyl-4-(1-methyl-2-trimethoxysilylethyl)cyclohexane; and 1,2-epoxy-4-(2-trimethoxysilylethyl)cyclohexane etc.

In certain exemplary embodiments, epoxy-functional silane such as bis or tris epoxy siloxanes may be used.

According to another exemplary embodiment, the amino-functional silane in the adhesion promoter composition has a Formula (II):

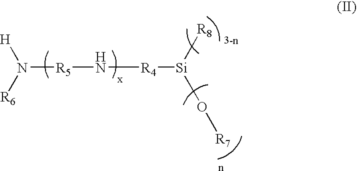

in which R₄ and R₅ are independent of each other a C₁₋₆ hydrocarbon divalent group, R₆ is a hydrogen or and a C₁₋₆ hydrocarbon group, R₇ is a C₁₋₆ hydrocarbon group, R₈ is a C₁₋₆ saturated or unsaturated hydrocarbon group, and n=1, 2, or 3.

Suitable examples of the amino-functional silane include, but are not limited to, H₂N(CH₂)₃Si(OCH₃)₃ (3-aminopropyltrimethoxysilane, available under the commercial name VM651 from HD Microsystems, H₂N(CH₂)₃Si(OCH₂CH₃)₃, H₂N(CH₂)₃Si(OCH₂CH₂OCH₃)₃, H₂N(CH₂)₄Si(OCH₃)₃, H₂NCH₂CH(CH₃)CH₂CH₂SiCH₃(OCH₃)₂, H₂N(CH₂)₂HN(CH₂)₃Si(OCH₃)₃, CH₃NH(CH₂)₂HN(CH₂)₃Si(OCH₃)₃, and H₂N(CH₂)₂HN(CH₂)₃Si(CH═CH₂)(OCH₃)₂ etc.

Suitable examples of the amino-functional silane may include 2 or 3 or more amino groups.

Reaction products of amino-functional silane and epoxy-functional silane may be reaction product of, for example, 3-glycidoxypropyltrimethoxysilane and 3-aminopropyltrimethoxysilane; 3-glycidoxypropyltrimethoxysilane and [3-(2-aminoethyl)aminopropyl]trimethoxysilane; 1,2-epoxy-4-(2-trimethoxysilylethyl)cyclohexane and 3-aminopropyltrimethoxysilane; 1,2-epoxy-4-(2-trimethoxysilylethyl)cyclohexane and [3-(2-aminoethyl)aminopropyl]trimethoxysilane; 1,2-epoxy-2-methyl-4-(1-methyl-2-trimethoxysilylethyl)cyclohexane and 3-aminopropyltrimethoxysilane; and 1,2-epoxy-2-methyl-4-(1-methyl-2-trimethoxysilylethyl)cyclohexane and [3-(2-aminoethyl)aminopropyl]trimethoxysilane.

Methods of preparing amino-functional silanes such as alkoxysilanes are well known in the art as exemplified in U.S. Pat. No. 3,888,815 to Bessmer et al. Methods of preparing epoxy-functional alkoxysilanes, such as a hydrosilylation addition reaction of alkenyl-containing epoxy compounds with trialkoxysilanes, and methods of preparing vinyl trialkoxysilanes, such as the reaction of vinyltrichlorosilane with alcohols, are also well known in the art.

Reaction products of amino-functional silanes and epoxy-functional silanes can be prepared using well known methods of reacting epoxy-containing compounds with amines. The reaction is typically carried out using about a 1:1 mole ratio of epoxy groups in the epoxy-functional silane to nitrogen-bonded hydrogen atoms in the amino-functional silane. The two compounds can be reacted either in the presence of an inert organic solvent, such as toluene, or in the absence of a solvent. The reaction can be carried out at room temperature or an elevated temperature, for example, from about 23 to about 100° C.

In a variety of exemplary embodiments, the adhesion promoter composition comprising an epoxy-functional silane and an amino-functional silane may be dissolved in any suitable solvent such as alcohol, prior to contacting the optoelectronic component to be encapsulated.

In an exemplary embodiment, the adhesion promoter composition is made from commercially available epoxy-functional silane and amino-functional silane. For example, 3-aminopropyltrimethoxysilane (VM651) and 3-glycidoxypropyl-trimethoxysilane in approximately 0.25% by weight in methanol (commercial name Glymo from Aldrich Chemical) can be combined and spray coated onto the inorganic surface of an LED device prior to air drying and subsequent molding. VM651 is good for adhering inorganic to inorganic and GLYMO for adhering organic to organic like materials. The use of the two distinct adhesion promoters in tandem bestows numerous benefits to an optoelectronic product, for example, structural integrity. Moreover, the combination of the two promoters cures into a completely transparent material adhering the organic material; and the transparency is maintained throughout thermal shock testing and other accelerated aging methods.

Any known encapsulant formulation suitable for an optoelectronic device may be employed in the present invention after the optoelectronic device has been treated with the adhesion promoter composition as described above.

The present invention provides a method of integrating an encapsulant into an optoelectronic device, comprising: (a) contacting the optoelectronic device to be encapsulated with an adhesion promoter composition comprising an epoxy-functional silane and an amino-functional silane; and (b) applying an encapsulant formulation onto the optoelectronic device that has been treated with the adhesion promoter composition.

Encapsulation techniques for solid-state devices comprise casting, resin transfer molding and the like. After the solid-state device is enveloped in the uncured formulation, typically performed in a mold, the formulation is cured. The curing may be conducted in one or more stages using methods such as thermal, UV, electron beam techniques, or combinations thereof. For example, thermal cure may be performed at temperatures in one embodiment in a range of between 20° C. and about 200° C., in another embodiment in a range between about 80° C. and about 200° C., in still another embodiment in a range between about 100° C. and about 200° C., and in still another embodiment in a range between about 120° C. and about 160° C. Also in other embodiments the formulation can be photo-chemically cured, initially at about room temperature. Although some thermal excursion from the photochemical reaction and subsequent cure can occur, no external heating is typically required. In other embodiments, the formulations may be cured in two stages wherein an initial thermal or UV cure, for example, may be used to produce a partially hardened resin. This material, which is easily handled, may then be further cured using, for example, either thermal or UV techniques, to produce a material with the desired thermal performance (for example glass transition temperature (Tg) and coefficient of thermal expansion (CTE)), optical properties and moisture resistance etc. required for encapsulated solid state devices.

The following examples are included to provide guidance to those skilled in the art in practicing the claimed invention. The examples provided are merely representative of the work that contributes to the teaching of the present application. Accordingly, these examples are not intended to limit the invention, as defined in the appended claims, in any manner.

### EXAMPLES

Adhesion promoters including VM651 and GLYMO were used as purchased. VM651 is good for adhering inorganic to inorganic materials and GLYMO for adhering organic to organic materials such as two chemically dissimilar polymers. Use of these adhesion promoters together at a loading of 0.25% each in methanol, yielded a combination that can be applied to metallic lead frames prior to molding. The material was applied by pipette and air dried prior to placement in the mold. The application of the promoter combination can also be made by spraying. Any resin transfer moldable material can be employed. Nitto Denko's NT 300H is a characteristic resin transfer molding material that was tested along with other commercial resin transfer molding materials. Sapphire DOE, submount DOE, and dielectric layers such as SiO₂, SiN₃, Al, and polyimide were tested. The adhesion improvements were noted by die shear force (from 0 to about 6.5 kg/cm²) and successful molding of parts without delamination or peeling of any portion of the device.

The adhesion improvements were also measured after thermal shock treatment. Thermal shock was applied by taking the molded part from a low −40° C. to high 120° C. in 15 minute intervals and repeating. Acoustic imaging showed no delamination.

In Table 1, the results of the combined adhesion promoter system designated “B” show marked improvements in die shear versus individual or no adhesion promoters.

TABLE 1

| | | | | | % Acoustic Scan failures | |
|---|---|---|---|---|---|---|
| | | | | | Severe | Any |
| Adhesion | | Sapphire | Expt''l | Shear Results | Delamination, | delamination, |
| Promoter | Roughening | DOE | Number | samples 1–10 | all chips | excl. edges |
| No | Yes | | 1 | 0 | | |
| B | No | | 2 | 2.4 | 30.91% | 20.69% |
| No | No | | 3 | 0 | 47.06% | 75.00% |
| A | No | | 4 | 2.7 | | |
| A | Yes | | 5 | 2.7 | | |
| B | Yes | | 6 | 7.7 | 0.00% | 0.00% |
| Adhesion | Dielectric | Submount | | | | |
| Promoter | Layer | DOE | | | | |
| A | SiO2 | | 7 | 5.5 | | |
| B | SiN3 | | 8 | 5.2 | 6.85% | 10.00% |
| B | Al | | 9 | 4.7 | 14.29% | 5.00% |
| No | Al | | 10 | 0 | | |
| No | SiN3 | | 11 | 5.5 | | |
| No | SiO2 | | 12 | 6.4 | | |
| A | Al | | 13 | 1.6 | 46.67% | 50.00% |
| A | SiN3 | | 14 | 6.1 | | |
| A | Polyimide | | 15 | 7.1 | | |
| B | SiO2 | | 16 | 7.3 | 5.88% | 0.00% |
| No | Polyimide | | 17 | 5 | | |
| B | Polyimide | | 18 | 6.1 | | |

The adhesion improvement was also achieved on GELCore's prototype high power packages. In an embodiment, the adhesion improvement was also achieved on GELCore ThermalLED RTM encapsulant such as ThermalLED 3 (TL 3).

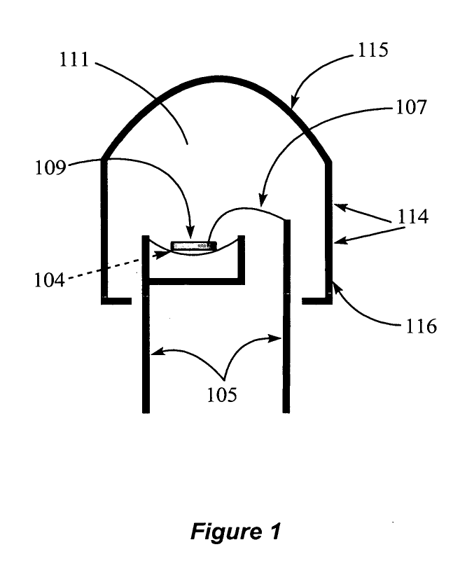

The present invention can be used in constructing a packaged solid state device that comprises (a) a package; (b) a chip; and (c) an encapsulant, as shown in FIG. 1.

With reference to FIG. 1, the figure schematically illustrates a light emitting device according to one embodiment of the present invention. The device contains a LED chip 104, which is electrically connected to a lead frame 105. For example, the LED chip 104 may be directly electrically connected to an anode or cathode electrode of the lead frame 105 and connected by a lead 107 to the opposite cathode or anode electrode of the lead frame 105, as illustrated in FIG. 1. In a particular embodiment illustrated in FIG. 1, the lead frame 105 supports the LED chip 104. However, the lead 107 may be omitted, and the LED chip 104 may straddle both electrodes of the lead frame 105 with the bottom of the LED chip 104 containing the contact layers, which contact both the anode and cathode electrode of the lead frame 105. The lead frame 105 connects to a power supply, such as a current or voltage source or to another circuit (not shown).

The LED chip 104 emits radiation from the radiation emitting surface 109. The LED may emit visible, ultraviolet or infrared radiation. The LED chip 104 may comprise any LED chip 104 containing a p-n junction of any semiconductor layers capable of emitting the desired radiation. For example, the LED chip 104 may contain any desired Group III-V compound semiconductor layers, such as GaAs, GaAlAs, GaN, InGaN, GaP, etc., or Group II-VI compound semiconductor layers such as ZnSe, ZnSSe, CdTe, etc., or Group IV-IV semiconductor layers, such as SiC. The LED chip 104 may also contain other layers, such as cladding layers, waveguide layers and contact layers.

The LED is packaged with an encapsulant 111 prepared according to the present invention. In one embodiment, the LED packaging includes encapsulant 111 located in a package, such as a shell 114. The shell 114 may be any plastic or other material, such as polycarbonate, which is transparent to the LED radiation. However, the shell 114 may be omitted to simplify processing if encapsulant 111 has sufficient toughness and rigidity to be used without a shell 114. Thus, the outer surface of encapsulant 111 would act in some embodiments as a shell 114 or package. The shell 114 contains a light or radiation emitting surface 115 above the LED chip 104 and a non-emitting surface 116 adjacent to the lead frame 105. The radiation emitting surface 115 may be curved to act as a lens and/or may be colored to act as a filter. In various embodiments the non-emitting surface 116 may be opaque to the LED radiation, and may be made of opaque materials such as metal. The shell 114 may also contain a reflector around the LED chip 104, or other components, such as resistors, etc., if desired.

In other embodiments, encapsulant may optionally contain a phosphor to optimize the color output of the LED in FIG. 1. For example, a phosphor may be interspersed or mixed as a phosphor powder with encapsulant 111 or coated as a thin film on the LED chip 104 or coated on the inner surface of the shell 114. Any phosphor material may be used with the LED chip. For example, a yellow emitting cerium doped yttrium aluminum garnet phosphor (YAG:Ce³⁺) may be used with a blue emitting InGaN active layer LED chip to produce a visible yellow and blue light output which appears white to a human observer. Other combinations of LED chips and phosphors may be used as desired. A detailed disclosure of a UV/blue LED-Phosphor Device with efficient conversion of UV/blue Light to visible light may be found in U.S. Pat. No. 5,813,752 (Singer) and U.S. Pat. No. 5,813,753 (Vriens).

While the packaged LED chip 104 is supported by the lead frame 105 according to one embodiment as illustrated in FIG. 1, the LED can have various other structures. For example, the LED chip 104 may be supported by the bottom surface 116 of the shell 114 or by a pedestal (not shown) located on the bottom of the shell 114 instead of by the lead frame 105.

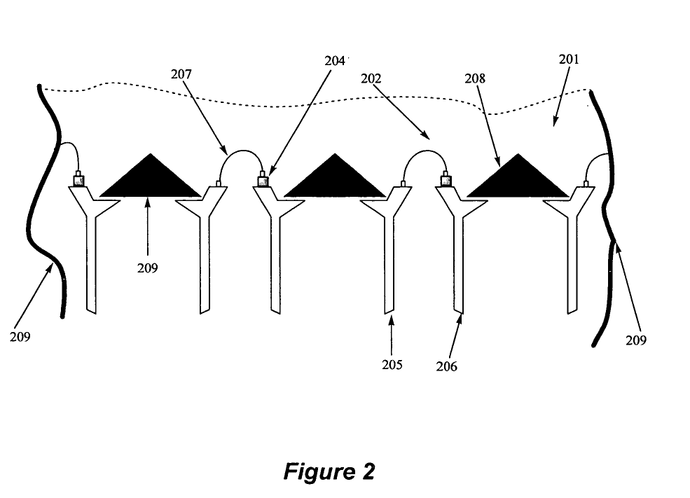

The present invention can be used in fabricating a LED array on a plastic substrate, as illustrated in FIG. 2. With reference to FIG. 2, the LED chips or die 204 are physically and electrically mounted on cathode leads 206. The top surfaces of the LED chips 204 are electrically connected to anode leads 205 with lead wires 207. The lead wires may be attached by known wire bonding techniques to a conductive chip pad. The leads 206, 205 comprise a lead frame and may be made of a metal, such as silver plated copper. The lead frame and LED chip array are contained in a plastic package 209, such as, for example, a polycarbonate package, a polyvinyl chloride package or a polyetherimide package. In some embodiments the polycarbonate comprises a bisphenol A polycarbonate. The plastic package 209 is filled with an encapsulant 201 of formulation according to the present invention. The package 209 contains tapered interior sidewalls 208, which enclose the LED chips 204, and form a light spreading cavity 202, which ensures cross fluxing of LED light.

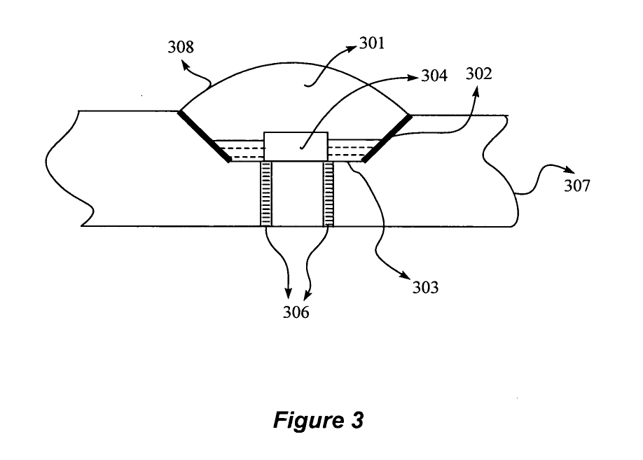

The present invention can be used in building a LED device in which the LED chip 304 is supported by a carrier substrate 307, as illustrated in FIG. 3. With reference to FIG. 3, the carrier substrate 307 comprises a lower portion of the LED package, and may comprise any material, such as plastic, metal or ceramic. Preferably, the carrier substrate is made out of plastic and contains a groove 303 in which the LED chip 304 is located. The sides of the groove 303 may be coated with a reflective metal 302, such as aluminum, which acts as a reflector. However, the LED chip 304 may be formed over a flat surface of the substrate 307. The substrate 307 contains electrodes 306 that electrically contact the contact layers of the LED chip 304. Alternatively, the electrodes 306 may be electrically connected to the LED chip 304 with one or two leads as illustrated in FIG. 3. If desired, the shell 308 or a glass plate may be formed over the encapsulant 301 to act as a lens or protective material.

The present invention may be used in constructing other semiconductor or solid state devices, for example, laser diode or other optoelectronic device chips, such as phototransistors and photodetectors. It should be understood that the method can also be used with non-light emitting chips and electronic components, for example, logic and memory devices, such as microprocessors, ASICs, DRAMs and SRAMs, as well as electronic components, such as capacitors, inductors and resistors.

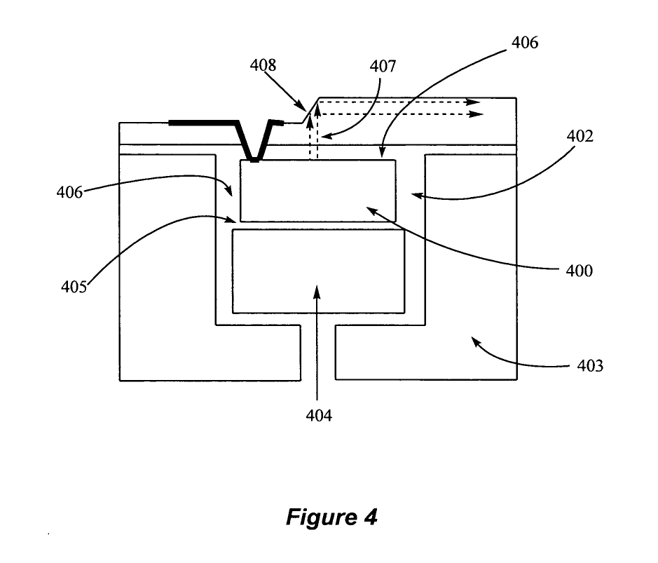

In one embodiment, the present invention is used with a vertical cavity surface emitting laser (VCSEL), as illustrated in FIG. 4. With reference to FIG. 4, the VCSEL 400 may be embedded inside a pocket 402 of a printed circuit board assembly 403. A heat sink 404 maybe placed in the pocket 402 of the printed circuit board 403 and the VCSEL 400 may rest on the heat sink 404. The encapsulant 406 of the present inventive formulation may be injected into the cavity 405 of the pocket 402 in the printed circuit board 403 and may flow around the VCSEL and encapsulate it on all sides and also form a coating top film 406 on the surface of the VCSEL 400. The top coating film 406 protects the VCSEL 400 from damage and degradation and at the same time is inert to moisture and is transparent and polishable. The laser beams 407 emitting from the VCSEL may strike the mirrors 408 to be reflected out of the pocket 402 of the printed circuit board 403.

In various embodiments, the present invention advantageously has many benefits such as rapid processing; ease of application; combination of organic and inorganic adhesion promoters; inclusion of epoxy moiety within organic adhesion promoter; improved adhesion promotion between two dissimilar surfaces; commercial availability of material; and etc.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All patents and publications cited herein are incorporated herein by reference.

1. A method of manufacturing an optoelectronic device, comprising:
(a) contacting at least a portion of an optoelectronic component with an adhesion promoter composition comprised of an epoxy-functional silane and an amino-functional silane; and
(b) applying an encapsulant formulation onto at least a portion of an optoelectronic component that has been treated with the adhesion promoter.

2. The method of claim 1, wherein the optoelectronic device is selected from the group consisting of light emitting diodes (LEDs), charge coupled devices (CCDs), large scale integrations (LSIs), photodiodes, vertical cavity surface emitting lasers (VCSELs), phototransistors, photocouplers, and optoelectronic couplers.

3. The method of claim 1, wherein the adhesion promoter is contacted to an optoelectronic device component selected from the group consisting of semiconductor chip, lead frame, bond wire, solder, electrode, pad, contact layer, phosphor layer, dielectric layer and combinations thereof.

4. The method of claim 1, wherein the adhesion promoter composition is applied to the optoelectronic device by spraying, syringe dispensing, screen or stencil printing, ink jet printing, or simple pippetting.

5. The method of claim 4, wherein the adhesion promoter composition comprises an epoxy-functional silane and an amino-functional silane or their reaction product.

6. The method of claim 1, wherein the epoxy-functional silane comprises a Formula (I): 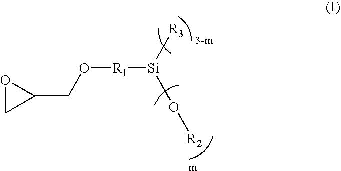
wherein R₁ is a C₁₋₆ hydrocarbon divalent group, R₂ is a C₁₋₆ hydrocarbon group, R₂ is a C₁₋₆ saturated or unsaturated hydrocarbon group, and m=1, 2, or 3.

7. The method of claim 1, wherein the epoxy-functional silane comprises 3-glycidoxypropyltrimethoxysilane.

8. The method of claim 1, wherein the epoxy-functional silane is selected from the group consisting of 3-glycidoxy-1,2-epoxy-4-(2-trimethoxysilylethyl)cyclohexane; 1,2-epoxy-2-methyl-4-(1-methyl-2-trimethoxysilylethyl)cyclohexane; 1,2-epoxy-4-(2-trimethoxysilylethyl)cyclohexane; and mixtures thereof.

9. The method of claim 1, wherein the epoxy-functional silane comprises 2 or more epoxy groups.

10. The method of claim 1, wherein the amino-functional silane comprises a Formula (II): 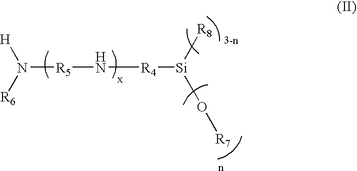
wherein R₄ and R₅ are independent of each other a C₁₋₆ hydrocarbon divalent group, R₆ is a hydrogen or and a C₁₋₆ hydrocarbon group, R₇ is a C₁₋₆ hydrocarbon group, R₈ is a C₁₋₆ saturated or unsaturated hydrocarbon group, and n=1, 2, or 3.

11. The method of claim 1, wherein the amino-functional silane is selected from the group consisting of H₂N(CH₂)₃Si(OCH₃)₃, H₂N(CH₂)₃Si(OCH₂CH₃)₃, H₂N(CH₂)₃Si(OCH₂CH₂OCH₃)₃, H₂N(CH₂)₄Si(OCH₃)₃, H₂NCH₂CH(CH₃)CH₂CH₂SiCH₃(OCH₃)₂, H₂N(CH₂)₂HN(CH₂)₃Si(OCH₃)₃, CH₃NH(CH₂)₂HN(CH₂)₃Si(OCH₃)₃, H₂N(CH₂)₂HN(CH₂)₃Si(CH═CH₃)(OCH₃)₂, and mixtures thereof.

12. The method of claim 1, wherein the amino-functional silane comprises 3-aminopropyltrimethoxysilane.

13. The method of claim 5, wherein the reaction product of amino-functional silane and epoxy-functional silane is selected from the group consisting of reaction product of 3-glycidoxypropyltrimethoxysilane and 3-aminopropyltrimethoxysilane; 3-glycidoxypropyltrimethoxysilane and [3-(2-aminoethyl)aminopropyl]trimethoxysilane; 1,2-epoxy-4-(2-trimethoxysilylethyl)cyclohexane and 3-aminopropyltrimethoxysilane; 1,2-epoxy-4-(2-trimethoxysilylethyl)cyclohexane and [3-(2-aminoethyl)aminopropyl]trimethoxysilane; 1,2-epoxy-2-methyl-4-(1-methyl-2-trimethoxysilylethyl)cyclohexane and 3-aminopropyltrimethoxysilane; 1,2-epoxy-2-methyl-4-(1-methyl-2-trimethoxysilylethyl)cyclohexane and [3-(2-aminoethyl)aminopropyl]trimethoxysilane; and mixture thereof.

14. The method of claim 1, wherein the epoxy-functional silane and the amino-functional silane are dissolved in a solvent.

15. The method of claim 14, wherein the solvent comprises an alcohol.

16. The method of claim 1, wherein the adhesion promoter composition comprises 3-aminopropyltrimethoxysilane (VM651) and 3-glycidoxypropyltrimethoxysilane in approximately 0.25% by weight in methanol.

17. The method of claim 1, wherein the optoelectronic device is selected from the group consisting of light emitting diodes (LEDs), charge coupled devices (CCDs), large scale integrations (LSIs), photodiodes, vertical cavity surface emitting lasers (VCSELs), phototransistors, photocouplers, flash light and optoelectronic couplers.

18. The method of claim 1, wherein the adhesion promoter composition is contacted to an optoelectronic component selected from the group consisting of semiconductor chip, lead frame, bond wire, solder, electrode, pad, contact layer, phosphor layer, dielectric layer and combinations thereof.

19. An optoelectronic device, made according to the method of claim 1.

20. The optoelectronic device of claim 19, which comprises a LED device including a chip and an encapsulant wherein an adhesion promoter composition is disposed between at least a portion of said chip and said encapsulant.
